(19) United States
(12) Patent Application Publication
(10) Pub. No.: US 2026/0089386 A1
(43) Pub. Date: Mar. 26, 2026

(54) PROCESSING APPARATUS, IMAGE PICKUP APPARATUS, EXTERNAL APPARATUS, PROCESSING METHOD, STORAGE MEDIUM, AND LENS APPARATUS

(71) Applicant: CANON KABUSHIKI KAISHA, Tokyo (JP)

(72) Inventor: HIDEKI SAKAI, Tochigi (JP)

(21) Appl. No.: 19/303,761

(22) Filed: Aug. 19, 2025

(30) Foreign Application Priority Data
Sep. 25, 2024 (JP) 2024-166301

(51) Int. Cl. H04N 23/63; H04N 23/60; H04N 23/69

(52) U.S. Cl. CPC H04N 23/633; H04N 23/665; H04N 23/69

(57) ABSTRACT

Processing apparatuses, image pickup apparatuses, external apparatuses, processing methods, storage media, and lens apparatuses are provided herein. One or more processing apparatuses may include one or more memories storing instructions, and one or more processors that, upon execution of the instructions, operate to acquire, from a lens apparatus, information on an F-number of the lens apparatus attached to an image pickup apparatus of a lens interchangeable type, acquire information on light attenuation of the lens apparatus, and generate information on a T-number of the lens apparatus using the information on the F-number and the information on the light attenuation.

### BACKGROUND

### Field of the Technology

The aspect of the disclosure relates to one or more embodiments of a processing apparatus configured to generate information to be used for imaging.

### Description of the Related Art

Some image pickup apparatuses control imaging using not only an F-number (sometimes referred to as Fno hereinafter) calculated from a focal length and a pupil diameter of an imaging lens, but also a T-number (sometimes referred to as Tno hereinafter) calculated from the F-number and transmittance of the imaging lens. Japanese Patent Application Laid-Open No. 2020-126181 discloses an imaging system that transmits conversion data from an F-number to a T-number stored by a lens apparatus to an image pickup apparatus, thereby allowing the image pickup apparatus to calculate the T-number and use it for control.

### SUMMARY

One or more embodiments of a processing apparatus according to one or more aspects of the disclosure may include one or more memories storing instructions, and one or more processors that, upon execution of the instructions, operate to acquire, from a lens apparatus, information on an F-number of the lens apparatus attached to an image pickup apparatus of a lens interchangeable type, acquire information on light attenuation of the lens apparatus, and generate information on a T-number of the lens apparatus using the information on the F-number and the information on the light attenuation. One or more external apparatuses including the above processing apparatus, processing methods corresponding to the above processing apparatus and storage medium storing a program that causes a computer to execute the processing method also constitute another aspect of the disclosure. One or more lens apparatuses may include one or more memories storing information on an F-number of the lens apparatus and information on light attenuation. One or more image pickup apparatuses may include one or more processors that operate to generate information on a T-number based on information on an F-number of an imaging optical system and information on light attenuation.

Features of the disclosure will become apparent from the following description of embodiments with reference to the attached drawings. The following description of embodiments is described by way of example.

### BRIEF DESCRIPTION OF THE DRAWINGS

FIG. 1 is a block diagram illustrating the configuration of an imaging system in this embodiment.

FIG. 2 illustrates Fno display in this embodiment.

FIG. 3 illustrates Tno display in this embodiment.

FIG. 4 is a flowchart illustrating processing in a first embodiment.

FIG. 5 is a flowchart illustrating processing in a second embodiment.

FIG. 6 is a flowchart illustrating processing in a third embodiment.

FIG. 7 illustrates a light amount attenuation table in the first and second embodiments.

FIG. 8 illustrates an Fno/Tno table in this embodiment.

FIG. 9 illustrates a light amount attenuation table in the third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the disclosure.

### First Embodiment

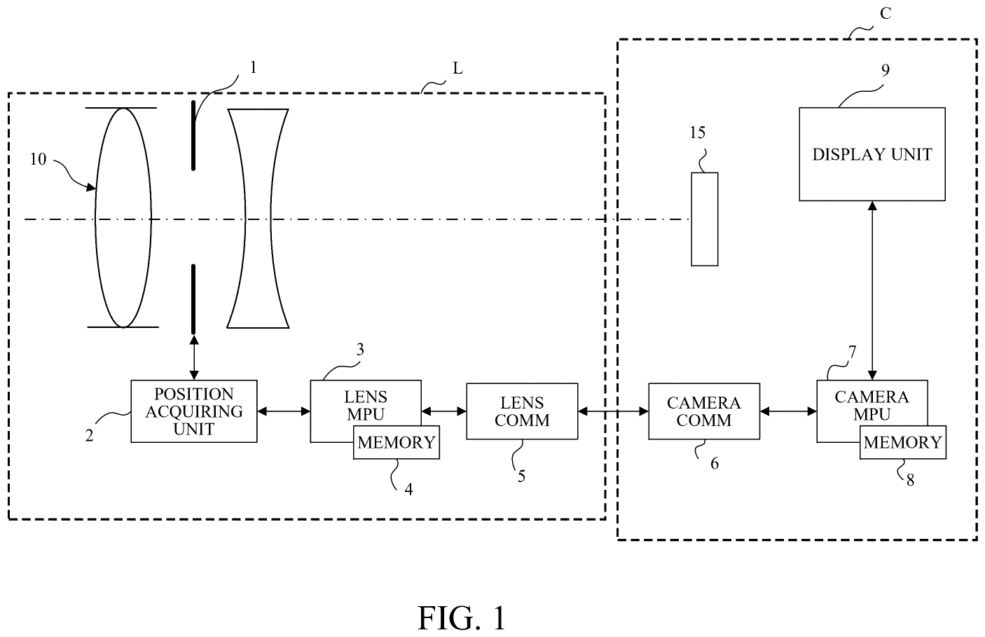

FIG. 1 illustrates the configuration of an imaging system according to a first embodiment. The imaging system includes a lens apparatus L and a lens interchangeable type image pickup apparatus C to which the lens apparatus L is detachably attached.

The lens apparatus L includes an imaging optical system 10, a position acquiring unit 2, a lens MPU 3, a lens memory 4 (one or more memories), and a lens communication unit 5. The imaging optical system 10 includes, as movable members, a zoom lens movable in the optical axis direction to perform magnification variation, a focus lens movable in the optical axis direction to perform focusing, and an aperture stop 1 configured to change an aperture diameter to adjust the light amount, and images light from an object (not illustrated).

The position acquiring unit 2 uses a position sensor such as a Hall element or an encoder to acquire information on the current aperture position (aperture diameter), a zoom position which is a position of the zoom lens, and a focus position which is a position of the focus lens, and outputs them to the lens MPU 3. The lens MPU 3 to which the information on the aperture position is input generates information on an F-number (aperture value) corresponding to the aperture position (referred to as F-number information hereinafter) by referring to the F-number conversion data stored (saved) in the lens memory 4, and transmits it to the image pickup apparatus through the lens communication unit 5. The F-number information may be information directly indicating the F-number, or may be information that can be converted into the F-number. The lens MPU 3 also transmits information on the zoom position and information on the focus position (referred to as zoom position information and focus position information hereinafter) to the image pickup apparatus through the lens communication unit 5. The zoom position information and focus position information may be information directly indicating the zoom position and focus position, or may be information that can be converted into them. The lens MPU 3 also transmits information on the model of the lens apparatus L (referred to as lens model information hereinafter) as lens information identifying (or distinguishing) the lens apparatus L to the image pickup apparatus. The lens model information may be any information that can identify the model of the lens apparatus L (individual, if necessary), such as a model, a serial number, and an identification number.

The image pickup apparatus C includes an image sensor 15, a camera communication unit 6, a camera MPU 7, a camera memory 8 (one or more memories), and a display unit 9. The image sensor 15 is a photoelectric conversion element such as a CCD sensor or a CMOS sensor, and photoelectrically converts (captures) an object image formed by the imaging optical system 10. The camera MPU 7 performs various processing for the imaging signal output from the image sensor 15 to generate image data, and outputs it to the display unit 9 to cause the display unit 9 to display it.

The camera MPU 7 can also receive the F-number information, zoom position information, focus position information, and lens model information from the lens apparatus L through the camera communication unit 6. The camera memory 8 previously stores (saves) information on the light amount attenuation in the imaging optical system for each model of a plurality of lens apparatuses that are attachable to the image pickup apparatus C (referred to as light amount attenuation information hereinafter). The light amount attenuation information is information on the transmittance of the imaging optical system. The information on the transmittance may be information indicating the transmittance itself, or may be information indicating the number of steps of light reduction that can be calculated from the transmittance on the optical axis of the imaging optical system. The light amount attenuation information may be information on a light shielding amount in the imaging optical system. The information on the transmittance and the information on the light shielding amount may be information that directly indicates them, or may be information that can be converted into them.

The camera MPU 7 reads out from the camera memory 8 the light amount attenuation information corresponding to the lens model information received from the lens apparatus L, and generates information on the T-number (referred to as T-number information hereinafter) from the light amount attenuation information and the F-number information received from the lens apparatus L.

For example, the T-number can be obtained from the F-number and the transmittance using the following equation:

$$\text{T-number} = \text{F-number} / √ ( transmittance ( \% ) / 100 )$$

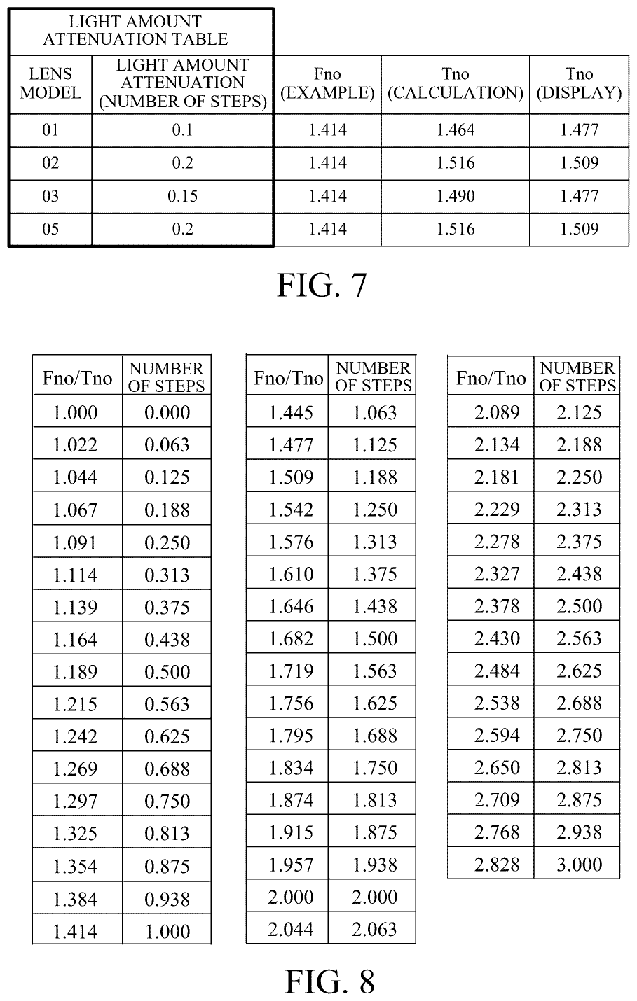

The acquisition of the T-number using the number of steps will be described later with reference to FIGS. 7 and 8.

The camera MPU 7 then outputs the generated T-number information to the display unit 9 to cause the display unit 9 to display it. The T-number information may be information indicating a numerical T-number, or may be non-numerical information such as an index relating to the T-number.

In this embodiment, the camera memory 8 previously stores light amount attenuation information for a plurality of lens apparatuses (models), but light amount attenuation information for each model may be stored in a server prepared on the cloud or the like. In this case, the camera MPU 7 that receives the lens model information from the lens apparatus L accesses the server and obtains the light amount attenuation information corresponding to the lens model information from the server.

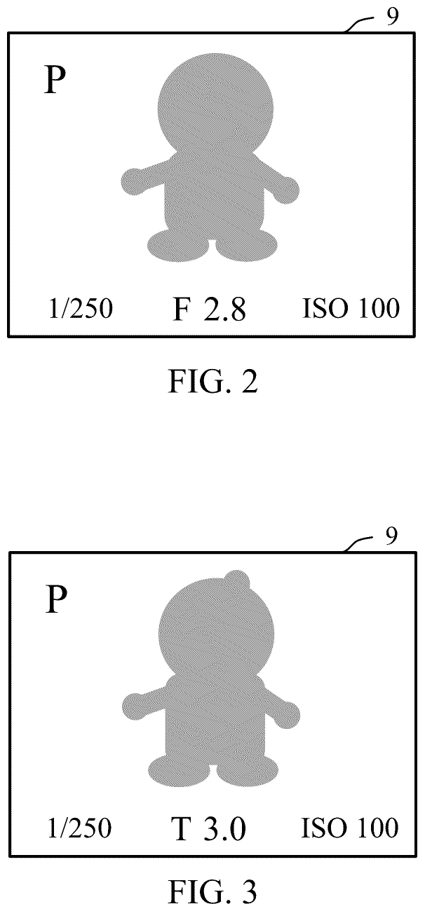

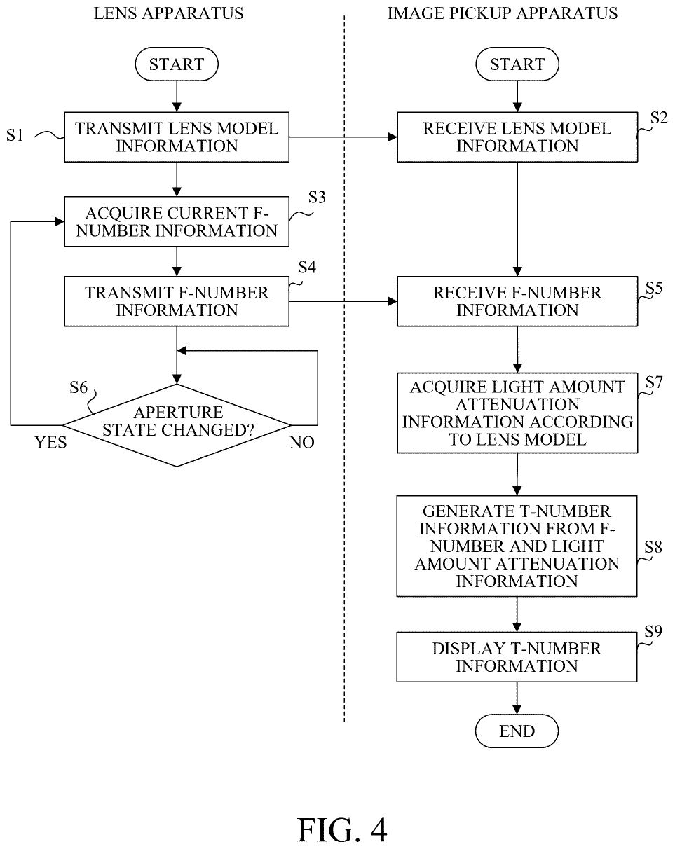

FIG. 2 illustrates F-number information (F2.8 as an example), which the camera MPU 7 has received from the lens apparatus L and caused the display unit 9 to display it. FIG. 3 illustrates T-number information (T3.0 as an example) calculated from F2.8 and light amount attenuation information (transmittance) by the camera MPU 7. P indicates a program mode as an imaging mode, 1/250 indicates a shutter speed, and ISO100 indicates an ISO speed. The shutter speed and ISO 100 are calculated by the camera MPU 7 using the F-number received from the lens apparatus L.

The display switching between the F-number information and the T-number information on the display unit 9 may be performed according to the user's selection. For example, the user can select to display F-number information relating to a blur diameter during imaging that emphasizes the blur amount, and can select to display T-number information relating to an exposure amount during imaging that emphasizes exposure. The user may be able to select to display both F-number information and T-number information so that he can determine both the blur amount and the exposure amount. In a case where the lens apparatus L that stores light amount attenuation information is attached to the image pickup apparatus C, the camera MPU 7 may automatically select to display T-number information.

A flowchart in FIG. 4 illustrates processing (a processing method) that the lens MPU 3 and the camera MPU 7, which are computers (one or more processors), are to execute according to a program (instructions stored in the one or more memories). The camera MPU 7 functions as a processing apparatus that includes an acquiring unit, a generator, and a control unit.

In step S1, the lens MPU 3 transmits lens model information on the lens apparatus L to the camera MPU 7. In step S2, the camera MPU 7 receives the model information.

Next, in step S3, the lens MPU 3 acquires the current aperture position from the position acquiring unit 2 and generates (acquires) F-number information. Next, in step S4, the lens MPU 3 transmits the F-number information to the camera MPU 7. In step S5, the camera MPU 7 receives the F-number information.

Next, in step S6, the lens MPU 3 determines whether the state of the aperture stop 1 has been changed, and in a case where it has been changed, the lens MPU 3 acquires the F-number information again in step S3 and transmits it to the camera MPU 7 in step S4.

In step S7, which is the next step after step S5, the camera MPU 7 acquires light amount attenuation information corresponding to the model information from the camera memory 8. Next, in step S8, the camera MPU 7 generates T-number information from the F-number information received from the lens MPU 3 and the light amount attenuation information acquired in step S7. Next, in step S9, the camera MPU 7 causes the display unit 9 to display the generated T-number information.

According to this embodiment, even if the lens apparatus L does not store light amount attenuation information, the image pickup apparatus can generate and display T-number information.

### Second Embodiment

Next, a second embodiment will be described. The configurations of the lens apparatus L and the image pickup apparatus C in this embodiment are the same as those of the first embodiment.

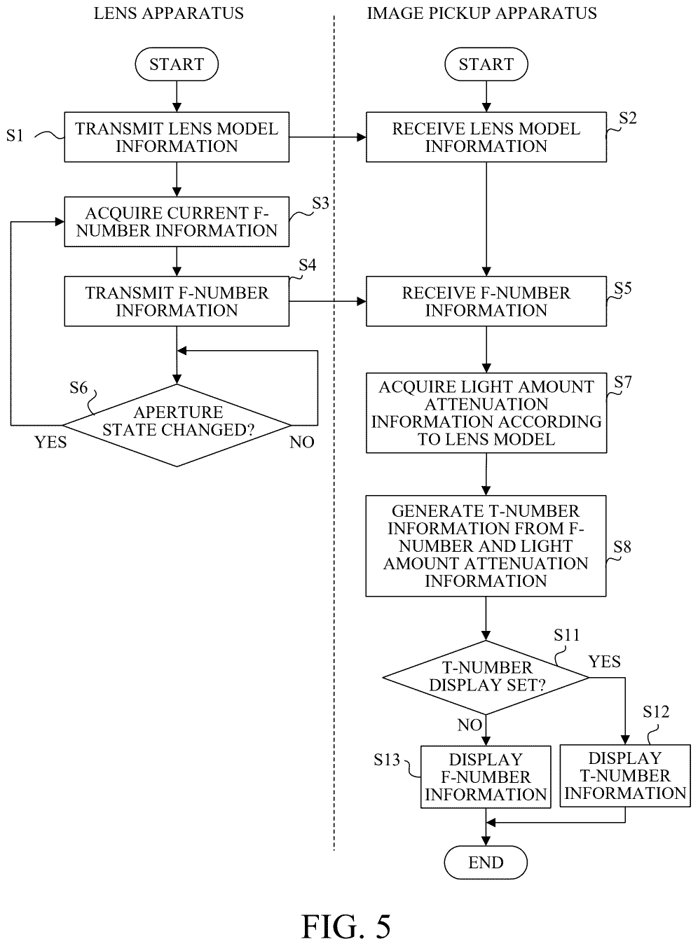

A flowchart in FIG. 5 illustrates processing to be executed by the lens MPU 3 and the camera MPU 7. The processing of steps S1, S3, S4, and S5 executed by the lens MPU 3 and the processing of steps S2, S5, S7, and S8 executed by the camera MPU 7 are the same as the processing of the steps of the same reference numerals in the first embodiment (FIG. 4).

In step S11 after step S8, the camera MPU 7 checks whether or not the user or the camera MPU 7 has selected to display a T-number. In a case where the display of the T-number has been selected, the flow proceeds to step S12, and the camera MPU 7 causes the display unit 9 to display the T-number information generated in step S8. On the other hand, in a case where the display of the T-number has not been selected (the display of the F-number has been selected), the flow proceeds to step S13, where the F-number information received in step S5 is displayed on the display unit 9.

### Third Embodiment

Next, a third embodiment will be described. The configurations of the lens apparatus L and the image pickup apparatus C in this embodiment are the same as those of the first embodiment.

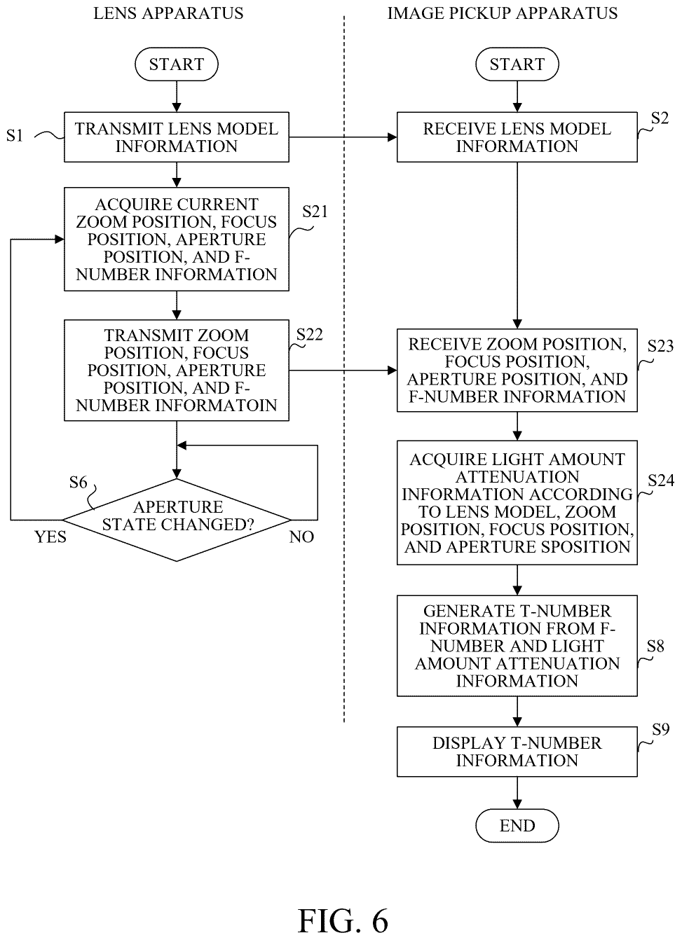

A flowchart in FIG. 6 illustrates processing to be executed by the lens MPU 3 and the camera MPU 7. The processing of steps S1 and S6 executed by the lens MPU 3 and steps S2, S8, and S9 executed by the camera MPU 7 are the same as the processing of the steps with the same reference numerals in the first embodiment (FIG. 4).

In step S21 after step S1, the lens MPU 3 acquires the current zoom position, focus position, and aperture position from the position acquiring unit 2 to generate (acquire) zoom position information, focus position information, aperture position information, and F-number information. Then, in step S22, the lens MPU 3 transmits the zoom position information, focus position information, aperture position information, and F-number information to the camera MPU 7. Then, the determination of step S6 is performed.

In step S23 after step S2, the camera MPU 7 receives the zoom position information, focus position information, aperture position information, and F-number information.

Next, in step S24, the camera MPU 7 obtains light amount attenuation information corresponding to the model information, zoom position information, focus position information, and aperture position information from the camera memory 8. Then, in step S8, T-number information is generated from the F-number information and the light amount attenuation information, and in step S9, the T-number information is displayed on the display unit 9.

A description will now be given of specific examples of the light amount attenuation information and T-numbers in the first to third embodiments.

FIG. 7 illustrates an example of table data (light amount attenuation table) stored in the camera memory 8 to obtain light amount attenuation information for each model of lens apparatus L (referred to as lens model hereinafter) in the first and second embodiments. This light amount attenuation table illustrates the number of steps as light amount attenuation information for each lens model. The camera MPU 7 reads out the number of steps corresponding to the lens model from the light amount attenuation table, and adds that number of steps to the current F-number. For example, in lens model 01, in a case where the current F-number is 1.414, the calculated T-number is 1.464, which is a value obtained by shifting the F-number by 0.1 steps in the light amount attenuation information (F-number×(√2)\hat{ }(the number of steps)=1.414×(√2)\hat{ }0.1≈1.464).

FIG. 8 illustrates an F-number/T-number table stored in the camera memory 8, which illustrates F-numbers and T-numbers for each predetermined number of steps. The camera MPU 7 calculates the T-number obtained by shifting the current F-number in this F-number/T-number table by the number of steps indicated in the light amount attenuation information, and obtains the T-number in the F-number/T-number table that is closest to the calculated T-number as the displayed T-number. For example, as described above, in a case where the calculated T-number is 1.464, 1.477, also illustrated in FIG. 7, is obtained as the displayed T-number that is closest to it, and is displayed on the display unit 9.

Such processing can select and display a proper T-number from a plurality of T-numbers that can be displayed without the need for complex calculations.

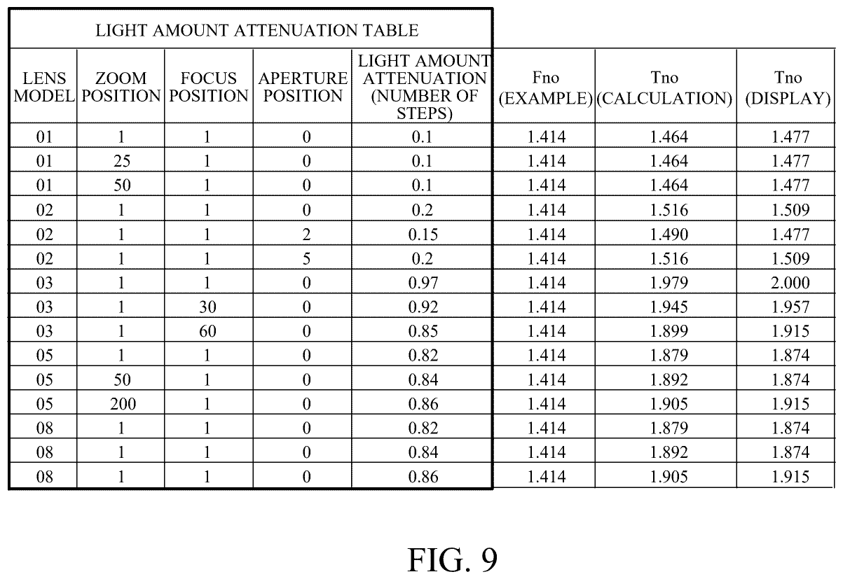

FIG. 9 illustrates an example of a light amount attenuation table stored in the camera memory 8 for acquiring light amount attenuation information for each lens model, zoom position, focus position, and aperture position in the third embodiment.

The camera MPU 7 reads out the step number corresponding to the lens model, zoom position, focus position, and aperture position from the light amount attenuation table, and acquires a calculated T-number by adding the step number to the current F-number. Then, a displayed T-number is acquired from the F-number/T-number table illustrated in FIG. 8.

The light amount attenuation table in FIG. 9 illustrates light amount attenuation information including not only the transmittance on the optical axis of the imaging optical system but also the light amount attenuation due to the peripheral light amount ratio that changes according to an image height for each zoom position, focus position, and aperture position for each lens model. In a case where the image pickup apparatus has a removable ND filter, for example, and the light amount attenuates inside the image pickup apparatus, it is also possible to include information on the light amount attenuation inside the image pickup apparatus (such as the transmittance of the ND filter) in the light amount attenuation information. Such light amount attenuation information can provide a more accurate T-number according to the actual exposure.

It is not necessary to provide light amount attenuation information corresponding to all of the zoom position, focus position, and aperture position, and light amount attenuation information may correspond to at least one of the zoom position, focus position, and aperture position. In this case, it is sufficient to use light amount attenuation information common to all positions for positions other than at least one position.

### Fourth Embodiment

In the first to third embodiments, the image pickup apparatus includes a built-in processing apparatus (camera MPU 7), but the processing apparatus may be provided outside the image pickup apparatus. For example, the processing apparatus may be provided in an external apparatus that can communicate with the lens apparatus or the image pickup apparatus. Examples of the external apparatus include a personal computer (PC) and an operation apparatus for remotely operating the lens apparatus and the image pickup apparatus. In this case, the processing apparatus can receive lens model information and F-number information from the lens apparatus or the image pickup apparatus, for example, and display T-number information generated from the F-number information and the light amount attenuation information corresponding to the lens model information, on a monitor provided in the external apparatus.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment according to the disclosure can generate, even if the lens apparatus does not store information about the light amount attenuation, information about the T-number of the lens apparatus.

This application claims the benefit of Japanese Patent Application No. 2024-166301, which was filed on Sep. 25, 2024, and which is hereby incorporated by reference herein in its entirety.

What is claimed is:

1. A processing apparatus comprising:
one or more memories storing instructions; and
one or more processors that, upon execution of the instructions, operate to:
acquire, from a lens apparatus, information on an F-number of the lens apparatus attached to an image pickup apparatus of a lens interchangeable type,
acquire information on light attenuation of the lens apparatus, and
generate information on a T-number of the lens apparatus using the information on the F-number and the information on the light attenuation.

2. The processing apparatus according to claim 1, wherein the one or more memories store information on light attenuation of each of a plurality of lens apparatuses attachable to the image pickup apparatus, and
wherein the one or more processors operate to acquire the information on the light attenuation of the lens apparatus attached to the image pickup apparatus from the one or more memories.

3. The processing apparatus according to claim 1, wherein the one or more processors operate to:
acquire, from the lens apparatus, lens information on the lens apparatus attached to the image pickup apparatus, and
acquire the information on the light attenuation corresponding to the lens information.

4. The processing apparatus according to claim 1, wherein the one or more processors operate to cause a display unit configured to display the information on the T-number.

5. The processing apparatus according to claim 4, wherein the one or more processors operate to display at least one selected from the information on the T-number and the information on the F-number on the display unit.

6. The processing apparatus claim 1, wherein the one or more processors operate to acquire the information on the light attenuation for each model of a plurality of lens apparatuses attachable to the image pickup apparatus.

7. The processing apparatus claim 1, wherein the information on the light attenuation includes information on transmittance of an imaging optical system in the lens apparatus.

8. The processing apparatus claim 1, wherein the information on the light attenuation changes according to a position of a movable member included in an imaging optical system in the lens apparatus, and
wherein the one or more processors operate to:
acquire information on the position of the movable member from the lens apparatus attached to the image pickup apparatus, and
generate the information on the T-number using the information on the light attenuation corresponding to the information on the position of the movable member.

9. The processing apparatus claim 1, wherein the information on the light attenuation includes information corresponding to a peripheral light ratio of an imaging optical system in the lens apparatus.

10. The processing apparatus claim 1, wherein the one or more processors cause the information on the light attenuation to include information on light attenuation inside the image pickup apparatus.

11. The processing apparatus claim 10, wherein the light attenuation inside the image pickup apparatus is caused by an ND filter.

12. An image pickup apparatus comprising:
an image sensor configured to capture an object image formed by the lens apparatus; and
the processing apparatus according to claim 1.

13. An external apparatus comprising:
the processing apparatus according to claim 1; and
a communication unit communicable with the lens apparatus or the image pickup apparatus.

14. A processing method comprising:
acquiring, from a lens apparatus, information on an F-number of the lens apparatus attached to an image pickup apparatus of a lens interchangeable type,
acquiring information on light attenuation of the lens apparatus, and
generating information on a T-number of the lens apparatus using the information on the F-number and the information on the light attenuation.

15. A non-transitory computer-readable storage medium storing a program that causes a computer to execute the processing method according to claim 14.

16. A lens apparatus comprising:
one or more memories storing information on an F-number and information on light attenuation of the lens apparatus.

17. An image pickup apparatus comprising:
one or more processors that operate to generate information on a T-number based on information on an F-number and information on light attenuation of an imaging optical system.
